(19) United States
(12) Patent Application Publication
(10) Pub. No.: US 2015/0301690 A1
(43) Pub. Date: Oct. 22, 2015

(54) INPUT-OPERATION DETECTION DEVICE, IMAGE DISPLAY APPARATUS, PROJECTOR APPARATUS AND PROJECTOR SYSTEM

(71) Applicants: Koji MASUDA, Kanagawa (JP); Yasuhiro Nihei, Kanagawa (JP); Shu Takahashi, Kanagawa (JP); Takeshi Ueda, Tokyo (JP); Hiroaki Tanaka, Kanagawa (JP); Shiori Ohta, Kanagawa (JP); Masahiro Itoh, Kanagawa (JP); Toshiaki Tokita, Kanagawa (JP); Takeshi Ogawa, Kanagawa (JP)

(72) Inventors: Koji MASUDA, Kanagawa (JP); Yasuhiro Nihei, Kanagawa (JP); Shu Takahashi, Kanagawa (JP); Takeshi Ueda, Tokyo (JP); Hiroaki Tanaka, Kanagawa (JP); Shiori Ohta, Kanagawa (JP); Masahiro Itoh, Kanagawa (JP); Toshiaki Tokita, Kanagawa (JP); Takeshi Ogawa, Kanagawa (JP)

(21) Appl. No.: 14/677,070

(22) Filed: Apr. 2, 2015

(30) Foreign Application Priority Data
Apr. 17, 2014 (JP) 2014-085080
Dec. 26, 2014 (JP) 2014-263887

(51) Int. Cl. G06F 3/042

(52) U.S. Cl. CPC G06F 3/0425

(57) ABSTRACT

According to an aspect of the present invention, an input-operation detection device for detecting a user input operation performed on at least a portion of a displayed image includes; a light emitter that emits detection light, an imaging unit including an imaging optical system and an image sensor and configured to capture an image of at least one of the displayed image and the input operation, and a processing unit that detects position, at which the input operation is performed, or motion, by which the input operation is provided, based on a result of image capture output from the imaging unit. The position where optical axis of the imaging optical system intersects a display surface of the displayed image and center of the displayed image are on the same side relative to a position where the imaging unit is mounted.

### CROSS-REFERENCE TO RELATED APPLICATIONS

The present application claims priority to and incorporates by reference the entire contents of Japanese Patent Application No. 2014-085080 filed in Japan on Apr. 17, 2014 and Japanese Patent Application No. 2014-263887 filed in Japan on Dec. 26, 2014.

### BACKGROUND OF THE INVENTION

1. Field of the Invention

Embodiments of the present invention relate to an input-operation detection device, an image display apparatus including the input-operation detection device, a projector apparatus, and a projector system including the projector apparatus. More particularly, embodiments of the invention relate to an input-operation detection device configured to detect an input operation performed by a user, an image display apparatus such as a projector apparatus, an interactive whiteboard apparatus, or a digital signage apparatus including the input-operation detection device, and a projector system.

2. Description of the Related Art

In recent years, what are generally referred to as interactive projector apparatuses having a function that allows writing characters, drawing, and the like to a projected image projected on a screen and a function that allows operations including enlarging/reducing the projected image and page-by-page scrolling are commercially available. These functions are typically implemented by detecting position and motion of input means and sending a result of detection to a computer or the like. The input means can be a finger(s) of an operator that touches the screen, a pen or a pointing tool held by an operator, or the like.

For instance, Japanese Laid-open Patent Application No. 2013-61552 discloses a projector apparatus including projection means that projects a projection image on a projection surface, imaging means that captures an image of an imaging area including the projection surface using a plurality of image sensors, distance obtaining means that obtains distance information indicating a distance to an object in the imaging area based on a plurality of images output from the plurality of image sensors, input-unit detecting means that detects, if the distance information indicates that the object is within a predetermined distance from the projection surface, the object as an input unit that performs an input operation on the projected image, and analyzing means that analyzes the input operation performed on the projected image based on position or motion of the input unit on the projected image.

The projector apparatus disclosed in Japanese Laid-open Patent Application No. 2013-61552 is susceptible to improvement in terms of reduction in detection error.

It is an object of the present invention to at least partially solve the problem in the conventional technology.

### SUMMARY OF THE INVENTION

It is an object of the present invention to at least partially solve the problems in the conventional technology.

According to the present invention, there is provided an input-operation detection device for detecting an input operation performed by a user on at least a portion of a displayed image, the input-operation detection device comprising: a light emitter configured to emit detection light toward an area where the input operation is to be performed; an imaging unit that includes an imaging optical system, and an image sensor, and that is configured to capture an image of at least one of the displayed image and the input operation and output a result of image capture; and a processing unit configured to detect position, at which the input operation is performed, or motion, by which the input operation is provided, based on the image capture result output from the imaging unit, a position where the optical axis of the imaging optical system intersects a display surface of the displayed image and center of the displayed image being on the same side relative to a position at which the imaging unit is mounted.

The present invention also provides an image display apparatus comprising the above-described input-operation detection device.

The present invention also provides a projector apparatus configured to operate in accordance with an input operation performed by a user on at least a portion of a projected image, the projector apparatus comprising: a light emitter configured to emit detection light toward an area where the input operation is to be performed; an imaging unit that includes an imaging optical system and an image sensor, and that is configured to capture an image of at least one of the projected image and the input operation and output a result of image capture; and a processing unit configured to detect position, at which the input operation is performed, or motion, by which the input operation is provided, based on the image capture result output from the imaging unit, a position where the optical axis the imaging optical system intersects a projection surface of the projected image and center of the projected image being on the same side relative to a position at which the imaging unit is mounted.

The present invention also provides a projector system comprising: the above-described projector apparatus; and a control device configured to perform image control based on the position, at which the input operation is performed, or the motion, by which the input operation is provided, obtained by the projector apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram of a schematic configuration of a projector system according to an embodiment of the present invention;

FIG. 2 is an explanatory diagram of a projector apparatus;

FIG. 3 is an explanatory diagram of a rangefinder unit;

FIG. 4 is an explanatory diagram of an imaging unit;

FIG. 5 is a flowchart for describing an input-operation-information detection process performed by a processing unit;

FIG. 6 is a first explanatory diagram of a comparative example;

FIG. 7 is a second explanatory diagram of the comparative example;

FIG. 8 is a first explanatory diagram of a first specific example;

FIG. 9 is a second explanatory diagram of the first specific example;

FIG. 10 is an explanatory diagram of numerical examples of the comparative example;

FIG. 11 is an explanatory diagram of numerical examples of the first specific example;

FIG. 12 is a first explanatory diagram of a second specific example;

FIG. 13 is a second explanatory diagram of the second specific example;

FIG. 14 is an explanatory diagram of numerical examples of the second specific example;

FIG. 15 is an explanatory diagram of a captured image;

FIG. 16 is an explanatory diagram of relationship between captured image and image sensor;

FIG. 17 is an explanatory diagram of numerical examples of a third specific example;

FIG. 18 is an explanatory diagram of approach A in the third specific example;

FIG. 19 is an explanatory diagram of approach B in the third specific example;

FIG. 20 is an explanatory diagram of approach D in the third specific example;

FIG. 21 is an explanatory diagram of approach E in the third specific example;

FIG. 22 is an explanatory diagram of a fourth specific example;

FIG. 23 is an explanatory diagram of numerical examples of the fourth specific example;

FIG. 24 is an explanatory diagram of the approach A in the fourth specific example;

FIG. 25 is an explanatory diagram of a condition where L1/M1=L2/M2 holds;

FIG. 26 is an explanatory diagram of a first modification of the projector apparatus;

FIG. 27 is a first explanatory diagram of a second modification of the projector apparatus;

FIG. 28 is a second explanatory diagram of the second modification of the projector apparatus;

FIG. 29 is an explanatory diagram of a first modification of the rangefinder unit;

FIG. 30 is an explanatory diagram of a second modification of the rangefinder unit;

FIG. 31 is a first explanatory diagram of a third modification of the rangefinder unit;

FIG. 32 is a second explanatory diagram of the third modification of the rangefinder unit;

FIG. 33 is an explanatory diagram of a third modification of the projector apparatus;

FIG. 34 is an explanatory diagram of an example of an interactive whiteboard apparatus; and

FIG. 35 is an explanatory diagram of an example of a digital signage apparatus.

### DETAILED DESCRIPTION OF THE PREFERRED EMBODIMENTS

In recent years, projector apparatuses having a function that allows writing characters, drawing, and the like to a projected image projected on a screen and a function that allows operations including enlarging/reducing the projected image and page-by-page scrolling are commercially available. These functions are typically implemented by detecting position and motion of a finger(s) of an operator that touches the screen, a pen or a pointing tool held by an operator, or the like, and sending a result of detection to a computer. Hereinafter, “a finger(s) of an operator that touches a screen, a pen or a pointing tool held by an operator, or the like” is referred to as “input means”.

As a method for detecting position and motion of input means, a method using a camera is known. For example, in a known method, position and motion of input means are detected by irradiating entire area where an image is projected of a screen with laser light and capturing light scattered from the input means with a camera. However, this method disadvantageously requires that laser light emitted from a laser light source should be parallel to the screen and in proximity of the screen, which makes it considerably difficult to arrange the laser light source at an appropriate position. Furthermore, this method is inapplicable to a curved screen, which is disadvantageous from the viewpoint of practical use.

As a technique for overcoming these disadvantages, a method of three-dimensionally detecting position and motion of input means using two cameras is proposed. An example of this method is known from Japanese Laid-open Patent Application No. 2013-61552.

However, a specific example of appropriate layout of the two cameras relative to a projected image is not disclosed in conventional methods using two cameras. Unless the two cameras are arranged at appropriate positions, an optical system having an angle of view wider than necessary is required. As a result, detection becomes susceptible to aberration, which can lead to an increase in detection error.

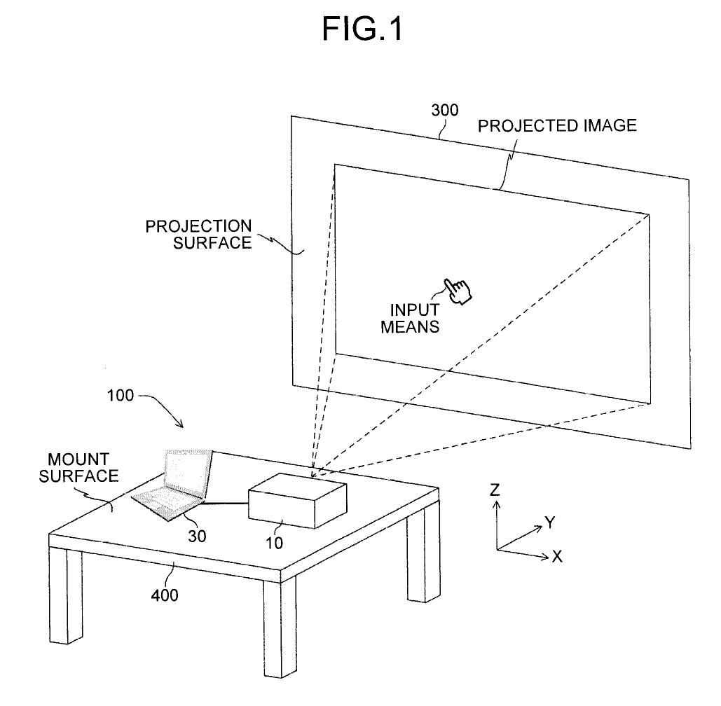

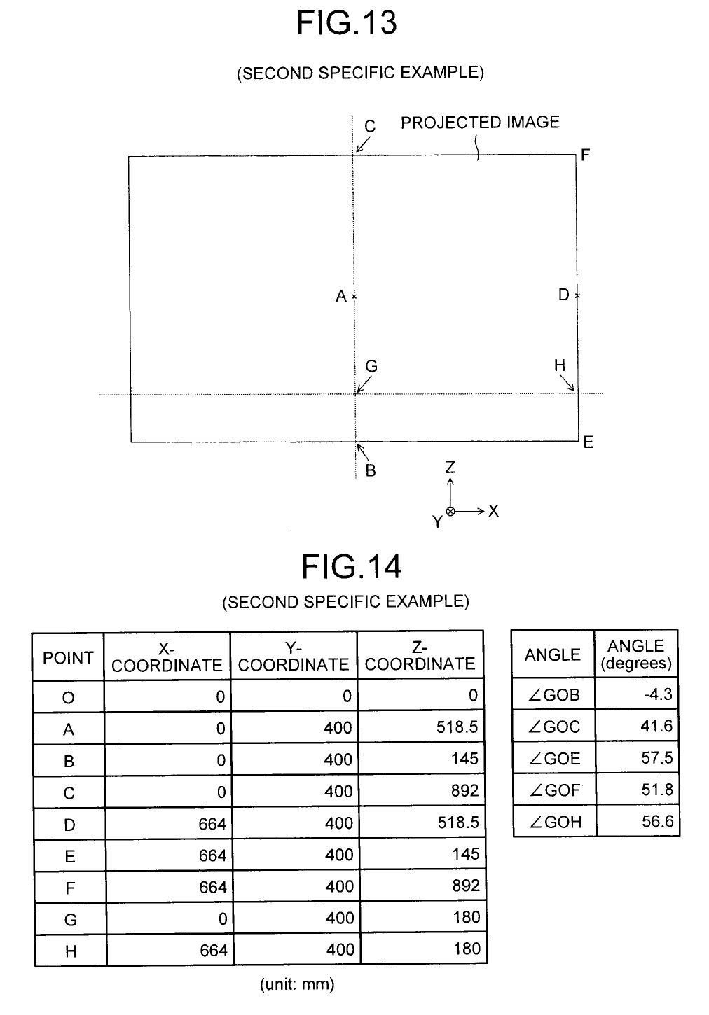

An embodiment of the present invention is described below with reference to FIGS. 1 through 25. FIG. 1 illustrates a schematic configuration of a projector system 100 according to the embodiment.

The projector system 100 includes a projector apparatus 10 and an image management apparatus 30. The projector apparatus 10 is an example of an image display apparatus including an input-operation detection device. An operator (user) performs an input operation on an image (hereinafter, sometimes referred to as “projected image”) projected on a projection surface of a screen 300 by touching either the projection surface or a position near the projection surface with input means such as a finger(s), pen, or a pointing tool.

The projector apparatus 10 and the image management apparatus 30 are placed on a desk, a table, or a dedicated pedestal (hereinafter, “stage 400”). Hereinafter, it is assumed that, in the three-dimensional Cartesian coordinates system, the direction perpendicular to a mount surface of the stage 400 where the apparatuses are placed is the Z-axis direction. It is assumed that the screen 300 is placed on the positive Y side of the projector apparatus 10. The projection surface is a surface of the screen 300 on the negative Y side. Meanwhile, as the projection surface, a surface of various items such as a board surface of a whiteboard or a wall surface can be used.

The image management apparatus 30 holds a plurality of image data and sends image information concerning an image to be projected (hereinafter, sometimes referred to as “projection image information”) and the like to the projector apparatus 10 in accordance with an instruction from an operator. Communication between the image management apparatus 30 and the projector apparatus 10 may be either wired communication via a cable such as a USB (universal serial bus) cable or wireless communication. As the image management apparatus 30, a personal computer (PC) on which predetermined program instructions are installed may be used.

When the image management apparatus 30 has an interface for a removable recording medium such as a USB memory or a secure digital (SD) card, an image stored in the recording medium can be used as a projection image.

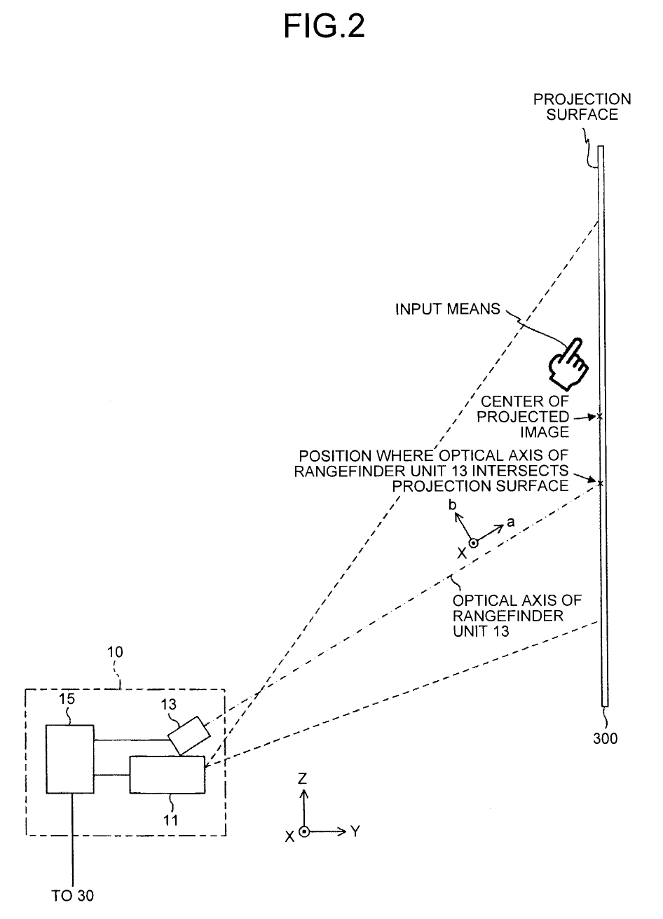

The projector apparatus 10 is what is generally referred to as an interactive projector apparatus and may include a projection unit 11, a rangefinder unit 13, and a processing unit 15 as illustrated in FIG. 2, for example. These units are housed in a casing (not shown).

In the projector apparatus 10 according to the embodiment, an input-operation detection device according to an aspect of the present invention is made up of the rangefinder unit 13 and the processing unit 15.

The projection unit 11 includes, as do conventional projector apparatuses, a light source, a color filter, and various optical devices and is controlled by the processing unit 15.

The processing unit 15 mutually communicates with the image management apparatus 30 and, upon receiving projection image information, performs predetermined image processing on the projection image information and performs projection on the screen 300 using the projection unit 11.

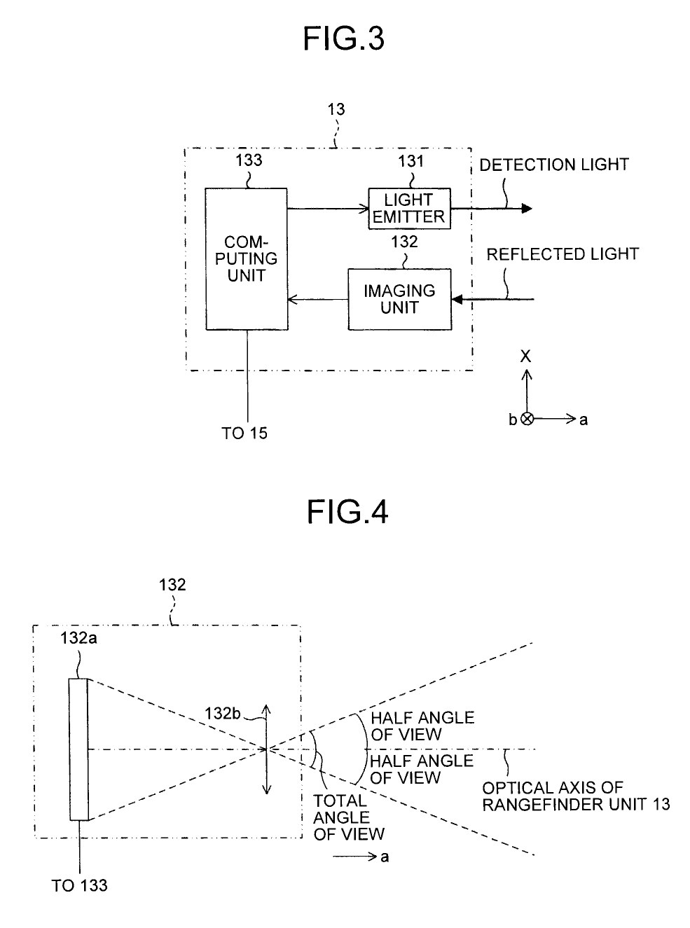

The rangefinder unit 13 may include a light emitter 131, an imaging unit 132, and a computing unit 133 as illustrated in FIG. 3, for example.

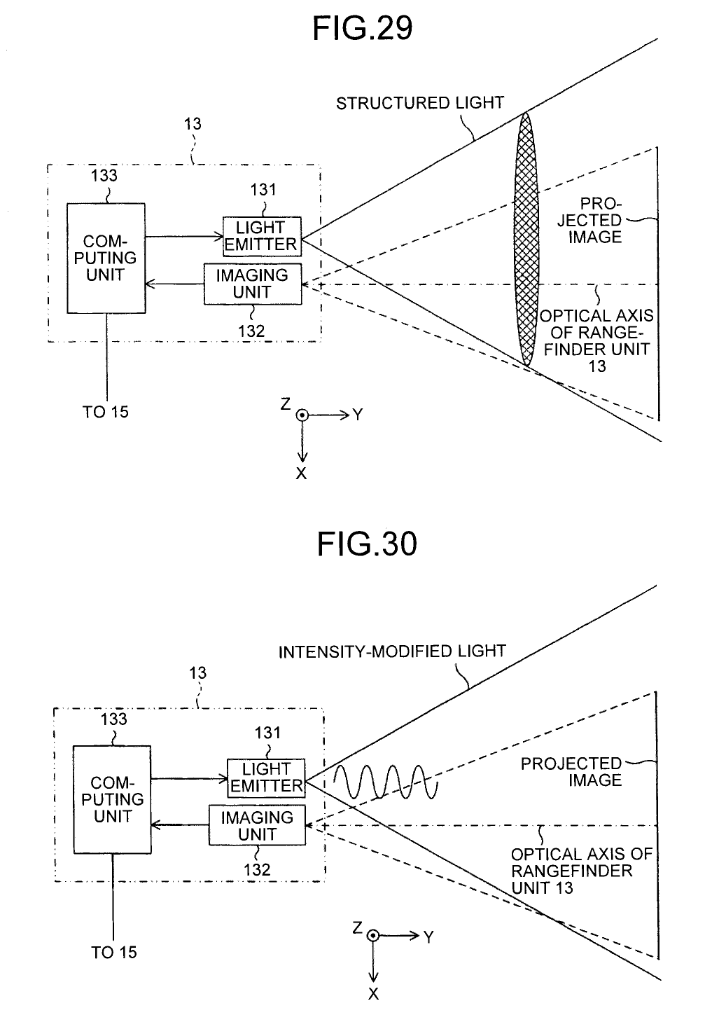

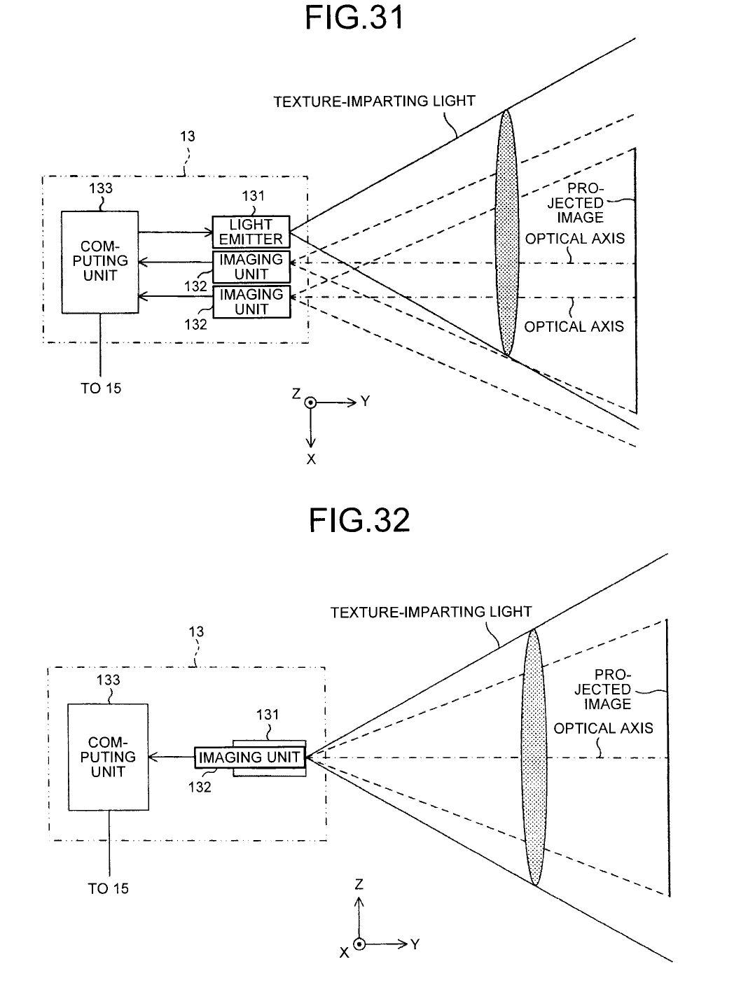

The light emitter 131 includes a light source that emits near-infrared light and emits light (detection light) toward a projected image. The processing unit 15 turns on and off the light source. As the light source, an LED (light-emitting diode), a semiconductor laser (LD (laser diode)), or the like can be used. The light emitter 131 may include an optical device and/or a filter for adjusting the light emitted from the light source. When including an optical device and/or a filter, the light emitter 131 can adjust an emission direction (angle) of the detection light or emit structured light (see FIG. 29), intensity-modulated light (see FIG. 30), or light that imparts texture to an object to be image-captured (hereinafter, “image-capture target”) (see FIG. 31) as the detection light, for example.

The imaging unit 132 may include an image sensor 132a and an imaging optical system 132b as illustrated in FIG. 4, for example. The image sensor 132a is an area-type image sensor. The image sensor 132a has a rectangular shape. The imaging optical system 132b causes light emitted from the light emitter 131 and reflected off an image-capture target to enter the image sensor 132a. In the embodiment, because the image sensor 132a is an area-type, two-dimensional information can be directly obtained without using an optical deflector such as a polygon mirror.

In the embodiment, the image-capture target of the imaging unit 132 can be the projection surface where no projection image is projected, a projected image projected on the projection surface, or the input means and a projected image.

The imaging optical system 132b is what is generally referred to as a coaxial optical system and has a defined optical axis. Hereinafter, the optical axis of the imaging optical system 132b may be referred to as the “optical axis of the rangefinder unit 13” for convenience. In the embodiment, the direction parallel to the optical axis of the rangefinder unit 13 is referred to as “a-axis direction”; the direction perpendicular to both the a-axis direction and the X-axis direction is referred to as “b-axis direction”. The imaging optical system 132b is configured to have an angle of view that allows capturing an image of the entire area of the projected image.

Referring back to FIG. 2, the rangefinder unit 13 is arranged so that the a-axis direction is tilted counterclockwise relative to the Y-axis direction and so that the position where the optical axis of the rangefinder unit 13 intersects the projection surface is on the negative Z side of center of the projected image. Put another way, in the Z-axis direction, the position where the rangefinder unit 13 is arranged and the position where the optical axis of the rangefinder unit 13 intersects the projected image are on the same side of the center of the projected image.

The computing unit 133 calculates distance information about the distance to the image-capture target based on information about when light is emitted by the light emitter 131 and information about when the image sensor 132a has captured reflected light. The computing unit 133 obtains three-dimensional information about a captured image or, in short, a depth map. Center of the thus-obtained depth map is on the optical axis of the rangefinder unit 13.

The computing unit 133 obtains depth maps of the image-capture target at predetermined time intervals (frame rate) and sends the depth maps to the processing unit 15.

The processing unit 15 calculates position or motion of the input means based on the depth maps obtained by the computing unit 133 and calculates input operation information that depends on the position or the motion. Furthermore, the processing unit 15 sends the input operation information to the image management apparatus 30.

Upon receiving the input operation information from the processing unit 15, the image management apparatus 30 performs image control in accordance with the input operation information. Hence, the input operation information is incorporated in the projected image.

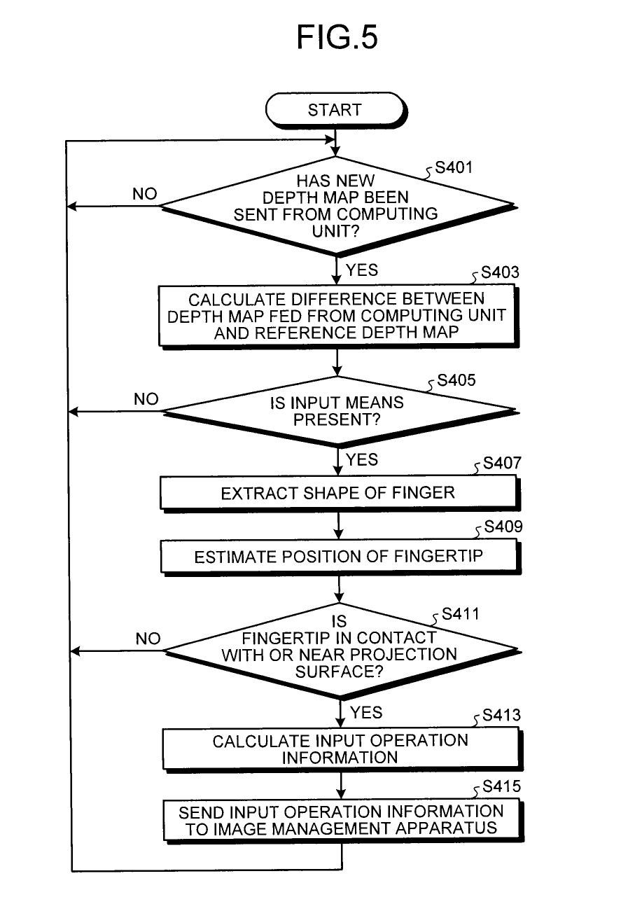

A process, performed by the processing unit 15, of calculating input operation information (hereinafter, sometimes referred to as the “input-operation-information detection process”) is described below with reference to the flowchart of FIG. 5.

A depth map is obtained in a condition where the input means is not present and held as a reference depth map in a memory (not shown) of the processing unit 15 in advance. It is assumed that the input means is a finger of an operator.

Whether or not a new depth map has been sent from the computing unit 133 is determined at the first step (S401). If a new depth map has not been sent from the computing unit 133 (NO at step S401), processing waits until a new depth map is sent. On the other hand, if a new depth map has been sent from the computing unit 133 (YES at step S401), processing proceeds to S403.

The difference between the depth map sent from the computing unit 133 and the reference depth map is calculated at step S403. Hereinafter, this difference may be referred to as the “depth difference map”.

Whether or not the input means is present is determined based on the depth difference map at the next step (step S405). If the depth difference map is equal to or lower than a predetermined threshold, it is determined that “the input means is not present”, and processing goes back to step S401. On the other hand, if the depth difference map is higher than the predetermined threshold, it is determined that “the input means is present”, and processing proceeds to step S407.

A shape of the finger is extracted based on the depth difference map at step S407.

Position of a fingertip of the finger is estimated from the extracted shape at the next step (step S409).

At the next step (step S411), the position (hereinafter, sometimes referred to as “differential distance”) of the fingertip from the projection surface in the Y-axis direction is calculated, and whether or not the fingertip is in contact with or near the projection surface is determined. If the differential distance is equal to or smaller than a preset value (e.g., 3 mm (millimeters)) (YES at step S411), processing proceeds to step S413.

The input operation information is calculated based on the position of the fingertip at step S413. The input operation information may be, for example, an input operation of clicking an icon as instructed by a projected image projected at the position of the fingertip or an input operation of drawing a letter or a line on a projected image during a period when the fingertip is moving.

The thus-obtained input operation information is sent to the image management apparatus 30 at the next step (step S415). Upon receiving the input operation information, the image management apparatus 30 performs image control in accordance with the input operation information. Put another way, the input operation information is incorporated in the projected image. Processing then goes back to step S401.

If the differential distance is greater than the preset value (e.g., 3 mm) (NO at step S411), processing goes back to step S401.

### First Specific Example

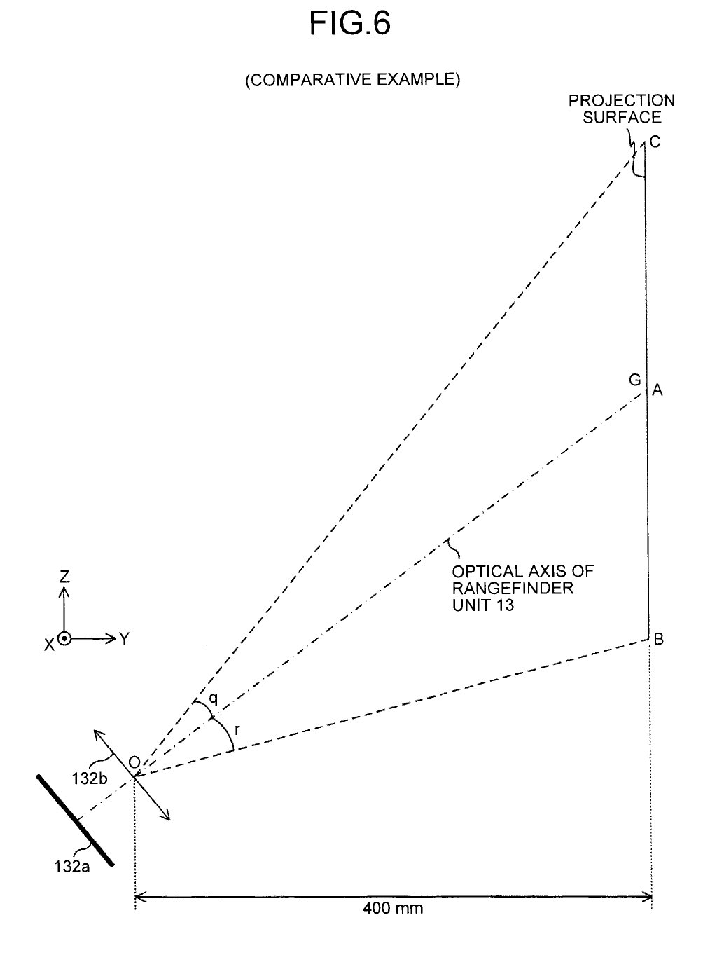

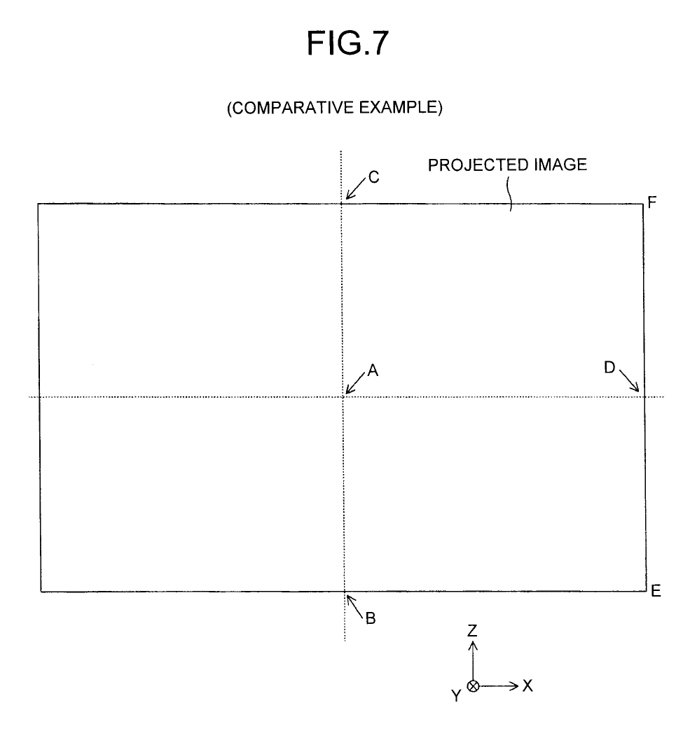

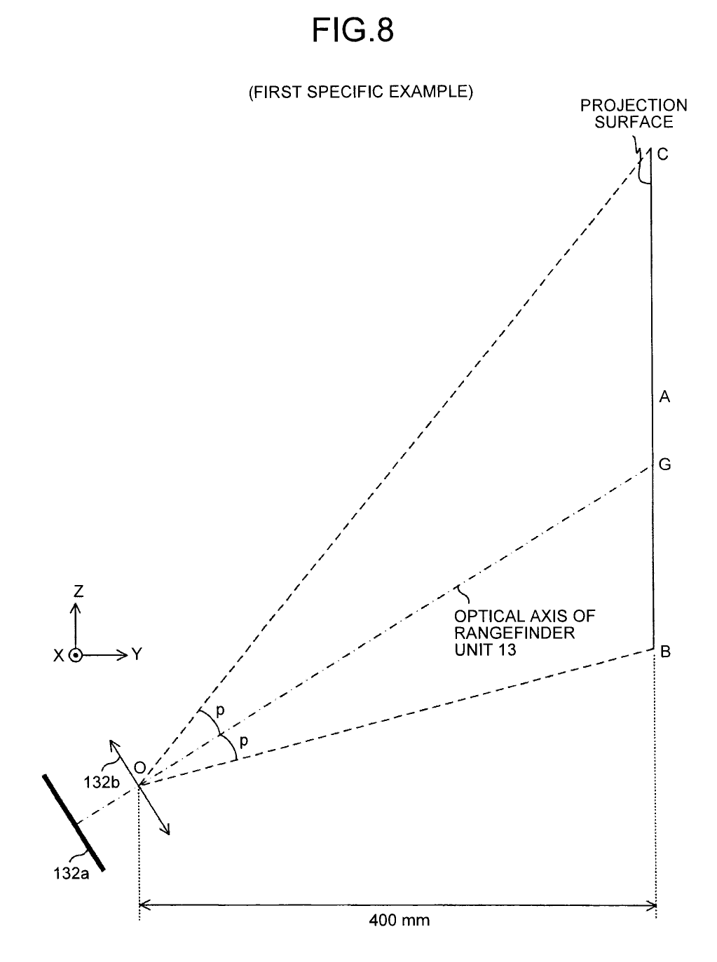

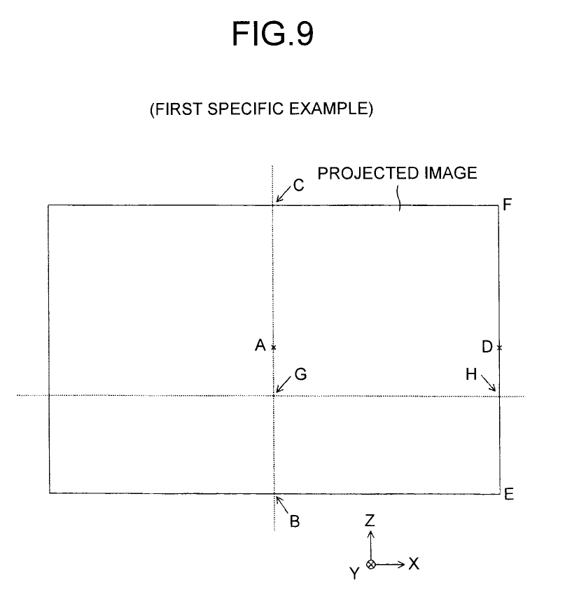

A first specific example and the comparative example are described below. FIGS. 6 and 7 illustrate the comparative example. FIGS. 8 and 9 illustrate the first specific example. The comparative example differs from the first specific example only in the tilt angle of the optical axis of the rangefinder unit 13 with respect to the Y-axis direction. In the comparative example, a position G where the optical axis of the rangefinder unit 13 intersects the projection surface coincides with center A of the projected image. In contrast, in the first specific example, the position G where the optical axis of the rangefinder unit 13 intersects the projection surface is on the negative Z side of the center A of the projected image.

A point where a straight line parallel to the Z-axis and extending through the center A of the projected image intersects an end of the projected image on the negative Z side is named as point B. A point where the straight line intersects an end of the projected image on the positive Z side is named as point C. A point where a straight line parallel to the X-axis and extending through the center A of the projected image intersects an end of the projected image on the positive X side is named as point D. A point where a straight line parallel to the Z-axis and extending through the point D intersects the end of the projected image on the negative Z side is named as point E. A point where the straight line intersects the end of the projected image on the positive Z side is named as point F. A point where, in the specific example 1, a straight line parallel to the X-axis and extending through the point G where the optical axis of the rangefinder unit 13 intersects the projection surface intersects the end of the projected image on the positive X side is named as point H. The center of the imaging optical system 132b is named as point O.

Specific numerical examples of the first specific example and the comparative example in a condition where the distance between the center O of the imaging optical system 132b and the projection surface in the Y-axis direction is 400 mm, and a 60-inch projection image (screen aspect ratio: 16:9) is projected onto the projection surface are determined.

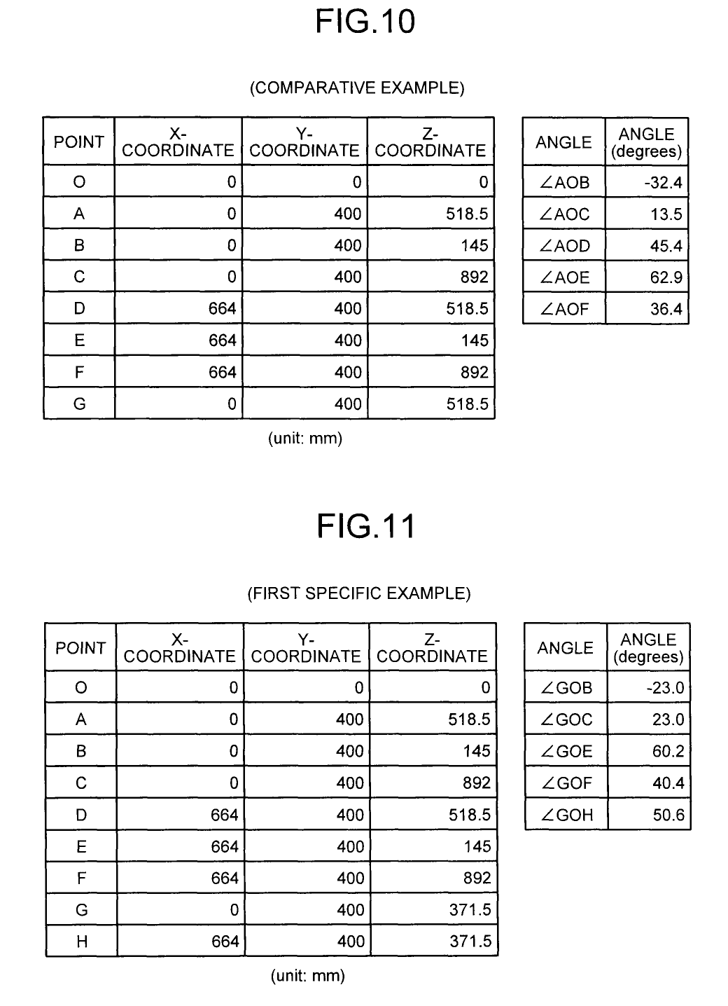

Numerical examples of the comparative example are given in FIG. 10. Numerical examples of the first specific example are given in FIG. 11. The values of the coordinates are given with respect to the origin which lies at the center O of the imaging optical system 132b. The end of the projected image on the negative Z side is at the position where the Z-coordinate is 145 mm. In the first specific example, the rangefinder unit 13 is configured to have a mount angle that places the position G where the optical axis of the rangefinder unit 13 intersects the projection surface at the Z-coordinate of 371.5 mm.

Because the screen size is 60 inch and the screen aspect ratio is 16:9, the screen is 1,328 mm in the X-axis direction and 747 mm in the Z-axis direction. The Z-coordinate of the center A of the projected image is 518.5 mm. In the first specific example, the position G where the optical axis of the rangefinder unit 13 intersects the projection surface is on the negative Z side of the center A of the projected image.

In the comparative example, the maximum half angle of view of the imaging optical system 132b is ∠AOE, which is 62.9 degrees. In contrast, in the first specific example, the maximum half angle of view of the imaging optical system 132b is ∠GOE, which is 60.2 degrees. Thus, the first specific example can reduce the half angle of view by no less than 2.7 degrees relative to the comparative example. The reduction of 2.7 degrees on the wide-angle side where the half angle of view is greater than 45 degrees (total angle of view: 90 degrees) is considerably advantageous in terms of aberration and manufacturing cost.

Reducing the maximum half angle of view can thus be achieved by configuring the rangefinder unit 13 to have such a mount angle that places the position G where the optical axis of the rangefinder unit 13 intersects the projection surface on the negative Z side of the center A of the projected image.

In the first specific example, values (absolute values) of ∠GOB and ∠GOC are equal to each other. Under this condition, the values (absolute values) ∠GOB and ∠GOC are at their minimum. Consequently, the angle of view of the imaging optical system 132b in the Z-axis direction is minimized, which leads to most favorable measurement in terms of optical accuracy in the Z-axis direction. In other words, in the comparative example, as shown in FIG. 6, the angle of view of the imaging optical system 132b is divided in two unequal angles [an angle r (∠AOS) and an angle q (∠AOC)], while in the specific example 1, as shown in FIG. 8, the angle of view of the imaging optical system 132b is divided in two equal angles [an angle p (∠GOB) and an angle p (∠GOC)].

### Second Specific Example

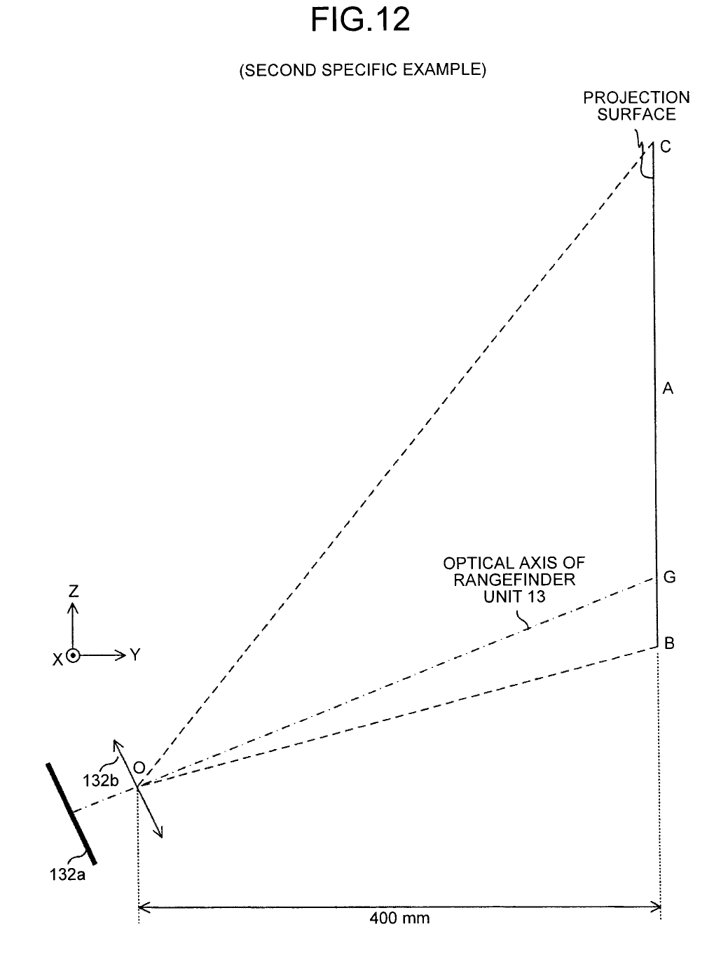

A second specific example is described below with reference to FIGS. 12 to 14. In the second specific example, the rangefinder unit 13 is configured to have a mount angle that places the position G where the optical axis of the rangefinder unit 13 intersects a projected image at the Z-coordinate of 180 mm. Also in the second specific example, the position G where the optical axis of the rangefinder unit 13 intersects the projected image is on the negative Z side of the center A of the projected image.

In the second specific example, the maximum half angle of view of the imaging optical system 132b is ∠GOE, 57.5 degrees. Thus, the second specific example can reduce the half angle of view by no less than 5.4 degrees relative to the comparative example. The reduction of 5.4 degrees on the wide-angle side where the half angle of view is greater than 45 degrees (total angle of view: 90 degrees) is considerably advantageous in terms of aberration and manufacturing cost. However, under this condition, the maximum angle of view in the Z-axis direction is increased.

Relationship between size of an image formed on a light-receiving surface of the image sensor 132a when a projected image is captured by the imaging unit 132 and number of pixels of the image sensor 132a is discussed below. Hereinafter, for convenience, the image formed on the light-receiving surface of the image sensor 132a may be referred to as “captured image”.

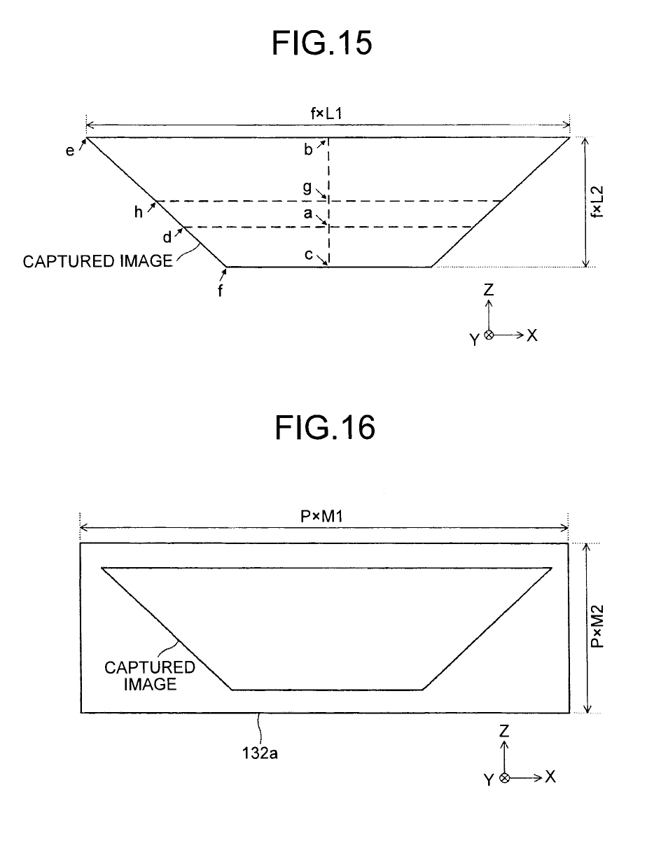

FIG. 15 illustrates an example of a captured image obtained from the first specific example. Referring to FIG. 15, the captured image has a trapezoidal shape because the projection surface and the light-receiving surface of the image sensor 132a are not parallel. Reference symbols a to h indicated on the captured image correspond to a to h of the projected image. The focal length of the imaging optical system 132b is denoted by f; the size of the captured image in the X-axis direction is denoted by f×L1; the size of the same in the Z-axis direction is denoted by f×L2.

When the number of pixels of the rectangular image sensor 132a in the X-axis direction is denoted by M1, and that in the Z-axis direction is denoted by M2, and pixel pitch is denoted by P, the size of the image sensor 132a in the X-axis direction is P×M1, and that in the Z-axis direction is P×M2.

A captured image captured by the image sensor 132a should desirably fit within the image sensor 132a so that the image sensor 1323a can capture a projected image. Put another way, the image sensor 132a should desirably be equal to or larger than the captured image in size as illustrated in FIG. 16, for example.

To implement this condition, Equations (1) and (2) should desirably be satisfied.

P×M1≧f×L1 (1)

P×M2≧f×L2 (2)

Equations (1) and (2) can be satisfied by reducing the focal length of the imaging optical system 132b, by increasing the pixel pitch, or by increasing the number of pixels. However, reducing the focal length of the imaging optical system 132b reduces imaging magnification of the projected image, which results in a decrease in spatial resolution of the captured image. Increasing the pixel pitch reduces the spatial resolution of the captured image. Increasing the number of pixels leads to a considerable increase in cost of the image sensor 132a.

Described below are approaches for reducing the difference in size between the image sensor 132a and the captured image so that the imaging unit 132 can capture the projected image without causing a decrease in the spatial resolution of the captured image nor a considerable increase in cost. Hereinafter, when it is unnecessary to distinguish between L1 and L2 or when it is unidentifiable between L1 and L2, L1 or L2 may be denoted by L. When it is unnecessary to distinguish between M1 and M2 or when it is unidentifiable between M1 and M2, M1 or M2 may be denoted by M.

### Approach A

Approach A makes the size of the image sensor 132a in the X-axis direction and that of the captured image equal to each other. More specifically, the approach A is implemented by configuring the image sensor 132a and the captured image to satisfy Equation (3) below. Equation (4) below derives from Equation (3).

P×M1=f×L1 (3)

P/f=L1/M1 (4)

To implement this condition, Equation (2) given above should desirably be satisfied in the Z-axis direction. Accordingly, the value of P/f given by Equation (4) should desirably satisfy Equation (5) below as well.

P/f≧L2/M2 (5)

In this way, the approach A optimizes the relationship between the size of the captured image and the number of pixels of the image sensor 132a in the X-axis direction.

### Approach B

Approach B makes the size of the image sensor 132a in the Z-axis direction and that of the captured image equal to each other. More specifically, the approach B is implemented by configuring the image sensor 132a and the captured image to satisfy Equation (6) below. Equation (7) below derives from Equation (6).

P×M2=f×L2 (6)

P/f=L2/M2 (7)

To implement this condition, Equation (1) given above should desirably be satisfied in the X-axis direction. Accordingly, the value of P/f given by Equation (7) should desirably satisfy Equation (8) below as well.

P/f≧L1/M1 (8)

In this way, the approach B optimizes the relationship between the size of the captured image and the number of pixels of the image sensor 132a in the Z-axis direction.

### Approach C

Approach C makes the size of the image sensor 132a in the X-axis direction and in the Z-axis direction and that of the captured image equal to each other. More specifically, the approach C is implemented by configuring the image sensor 132a and the captured image to satisfy Equations (4) and (7) given above. Equation (9) below derives from Equations (4) and (7).

L1/M1=L2/M2 (9)

In this way, the approach C optimizes the relationship between the size of the captured image and the number of pixels of the image sensor 132a in the X-axis direction and in the Z-axis direction.

Meanwhile, the image sensor 132a can be used in an orientation of being rotated 90 degrees about the a-axis. Under this condition, Equations (10) and (11) should desirably be satisfied.

P×M1≧f×L2 (10)

P×M2≧f×L1 (11)

Approaches for reducing the difference in size between the image sensor 132a and the captured image when the image sensor 132a is used in the orientation of being rotated 90 degrees are discussed below.

### Approach D

Approach D makes the size of the image sensor 132a in the X-axis direction and the size of the captured image in the Z-axis direction equal to each other. More specifically, the approach D is implemented by configuring the image sensor 132a and the captured image to satisfy Equation (12) below. Equation (13) below derives from Equation (12).

P×M2=f×L1 (12)

P/f=L1/M2 (13)

To implement this condition, Equation (10) given above should desirably be satisfied. Accordingly, the value of P/f given by Equation (13) should desirably satisfy Equation (14) below as well.

P/f≧L2/M1 (14)

The approach D optimizes the relationship between the size of the captured image and the number of pixels of the image sensor 132a in the Z-axis direction when the image sensor 132a is used in the orientation of being rotated 90 degrees.

### Approach E

Approach E makes the size of the image sensor 132a in the Z-axis direction and the size of the captured image in the X-axis direction equal to each other. More specifically, the approach E is implemented by configuring the image sensor 132a and the captured image to satisfy Equation (15) below. Equation (16) below derives from Equation (15).

P×M1=f×L2 (15)

P/f=L2/M1 (16)

To implement this condition, Equation (11) given above should desirably be satisfied. Accordingly, the value of P/f given by Equation (16) should desirably satisfy Equation (17) below as well.

P/f≧L1/M2 (17)

The approach E optimizes the relationship between the size of the captured image and the number of pixels of the image sensor 132a in the X-axis direction when the image sensor 132a is used in the orientation of being rotated 90 degrees.

### Approach F

Approach F is implemented by configuring the image sensor 132a and the captured image to satisfy Equations (13) and (15) given above. Equation (18) below derives from Equations (13) and (15).

L1/M2=L2/M1 (18)

In this way, the approach F optimizes the relationship between the size of the captured image and the number of pixels of the image sensor 132a in the X-axis direction and in the Z-axis direction when the image sensor 132a is used in the orientation of being rotated 90 degrees.

Some of the six approaches are specifically described below.

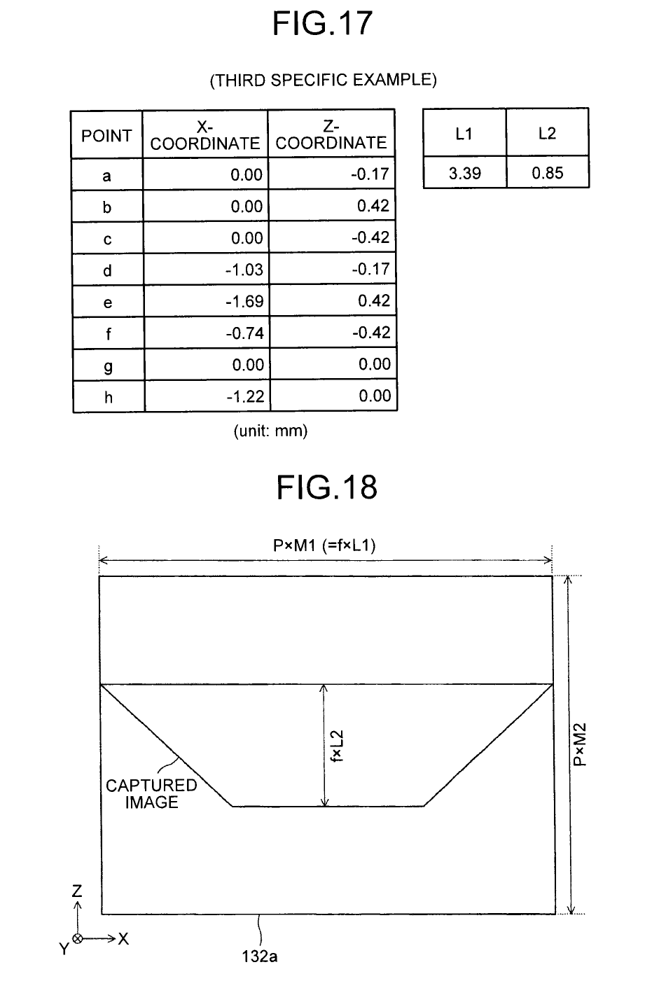

In advance of the description about the approaches, a third specific modification is described. It is assumed that the image sensor 132a has the VGA (registered trademark) (video graphics array) resolution (640×480), where M1=640 and M2=480. The rangefinder unit 13 is configured as in the first specific example. Specific numerical examples of coordinates of the points a to h and specific numerical examples of L1 and L2 are given in FIG. 17. The values of the coordinates are given with respect to the origin which lies at the point g. As the focal length f, a normalized focal length of 1 (mm) is used.

For example, when the approach A is used, the value of P/f is obtained using Equation (4) as: P/f=3.39/640=0.00529. Because the value of L2/M2 is obtained as: L2/M2=0.85/480=0.00177, Equation (5) given above is satisfied. Under this condition, the image sensor 132a can receive light from the entire captured image efficiently as illustrated in FIG. 18.

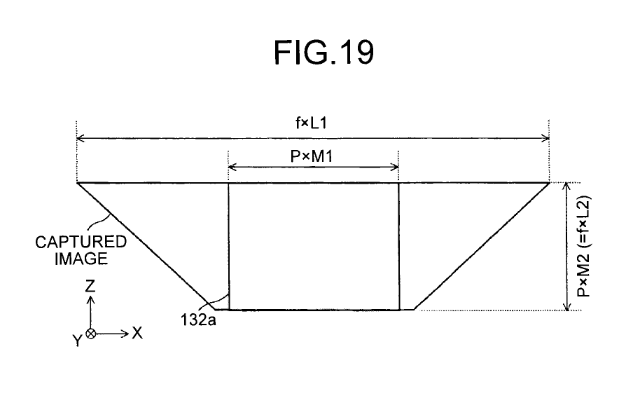

For another example, when the approach B is used, the value of P/f is obtained using Equation (7) as: P/f=0.85/480=0.00177. Because the value of L1/M1 is obtained as: L1/M1=3.39/640=0.00529, Equation (8) given above is not satisfied. Under this condition, the image sensor 132a cannot receive light from the entire captured image as illustrated in FIG. 19.

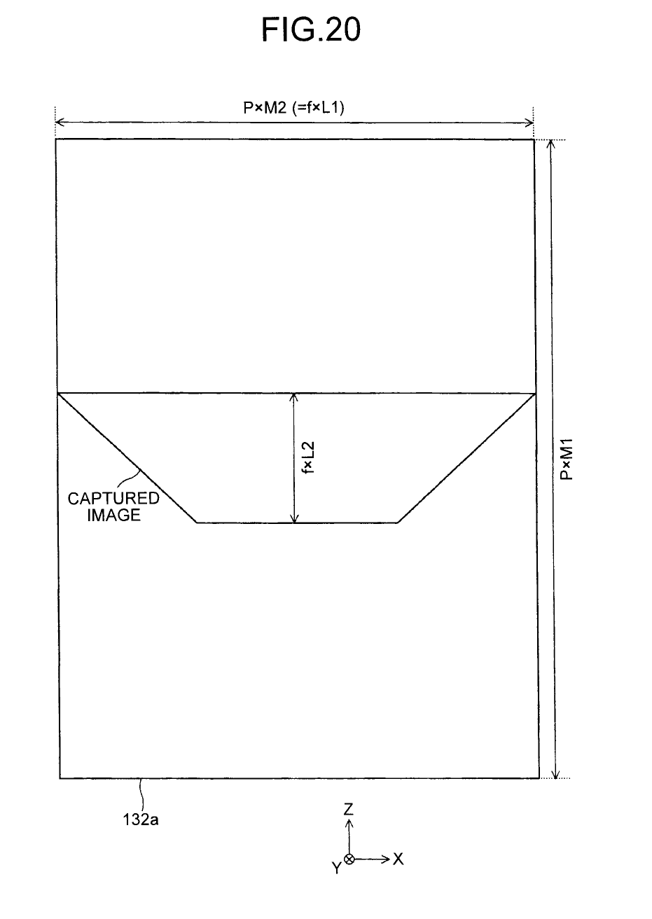

For another example, when the approach D is used, the value of P/f is obtained using Equation (13) as: P/f=3.39/480=0.00706. Because the value of L2/M1 is obtained as: L2/M1=0.85/640=0.00132, Equation (14) given above is satisfied. Under this condition, if the image sensor 132a is used in the orientation of being rotated 90 degrees, the image sensor 132a can receive light from the entire captured image efficiently as illustrated in FIG. 20.

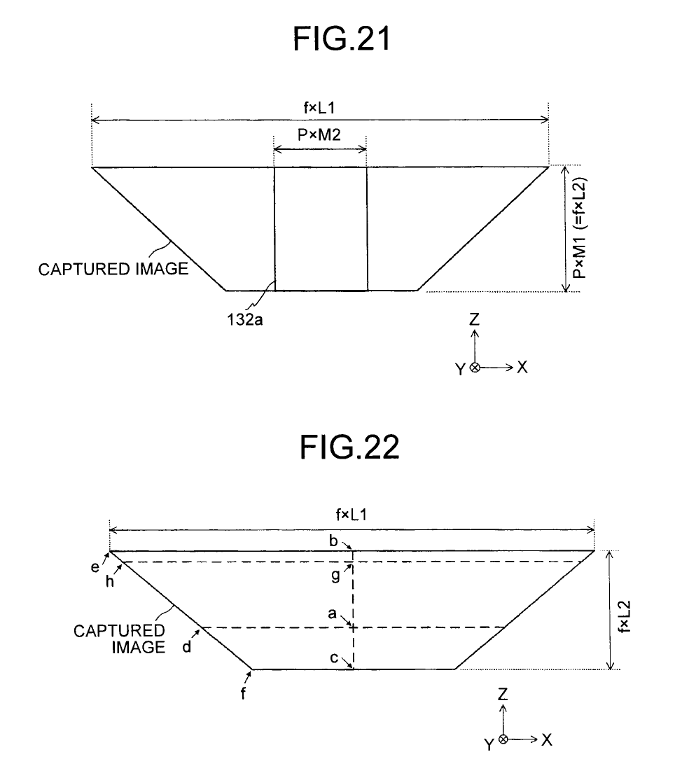

For another example, when the approach E is used, the value of P/f is obtained using Equation (16) as: P/f=0.85/640=0.00132. Because the value of L1/M2 is obtained as: L1/M2=3.39/480=0.00706, Equation (17) given above is not satisfied. Under this condition, even if the image sensor 132a is used in the orientation of being rotated 90 degrees, the image sensor 132a cannot receive light from the entire captured image as illustrated in FIG. 21.

Thus, when the approach A or the approach D is used in the third specific example, the imaging unit 132 can capture the projected image without causing a decrease in the spatial resolution of the captured image nor causing a considerable increase in cost.

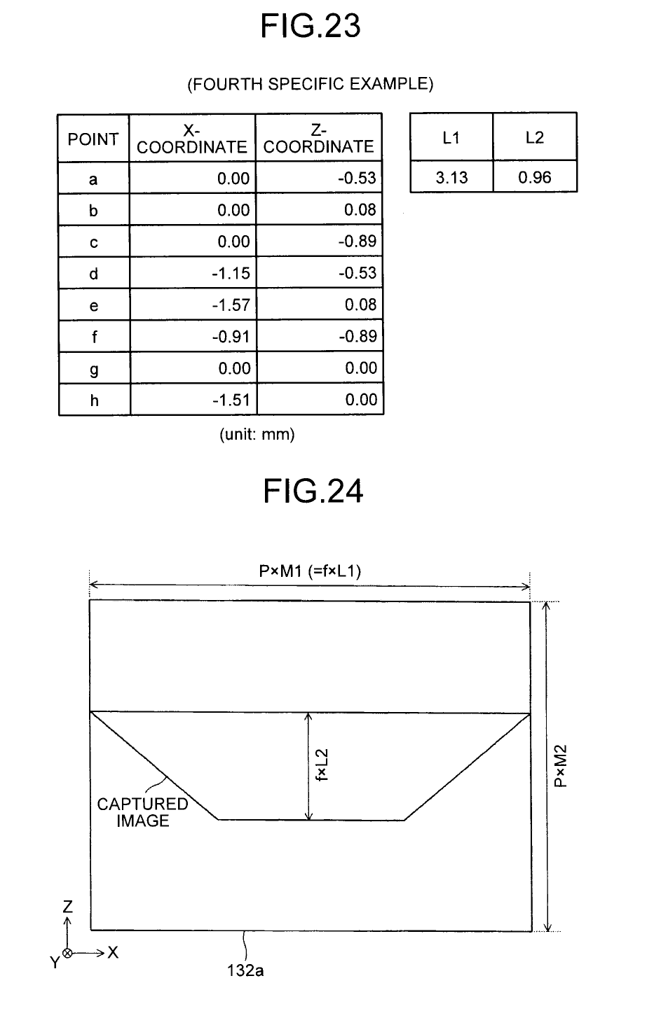

A fourth specific example is described below. It is assumed that the image sensor 132a has the VGA resolution (640×480), where M1=640 and M2=480. The rangefinder unit 13 is configured as in the second specific example. FIG. 22 illustrates an example of a captured image. Specific numerical examples of coordinates of the points a to h and specific numerical examples of L1 and L2 are given in FIG. 23. The values of the coordinates are given with respect to the origin which lies at the point g. As the focal length f, the normalized focal length of 1 (mm) is used.

For example, when the approach A is used, the value of P/f is obtained using Equation (4) as: P/f=3.13/640=0.00489. Because the value of L2/M2 is obtained as: L2/M2=0.96/480=0.00200, Equation (5) given above is satisfied. Under this condition, the image sensor 132a can receive light from the entire captured image efficiently as illustrated in FIG. 24.

For another example, when the approach B is used, the value of P/f is obtained using Equation (7) as: P/f=0.96/480=0.00200. Because the value of L1/M1 is obtained as: L1/M1=3.13/640=0.00489, Equation (8) given above is not satisfied. Under this condition, the image sensor 132a cannot receive light from the entire captured image.

For another example, when the approach D is used, the value of P/f is obtained using Equation (13) as: P/f=3.13/480=0.00652. Because the value of L2/M1 is obtained as: L2/M1=0.96/640=0.0015, Equation (14) given above is satisfied. Under this condition, if the image sensor 132a is used in the orientation of being rotated 90 degrees, the image sensor 132a can receive light from the entire captured image efficiently.

For another example, when the approach E is used, the value of P/f is obtained using Equation (16) as: P/f=0.96/640=0.0015. Because the value of L1/M2 is obtained as: L1/M1=3.13/480=0.00652, Equation (17) given above is not satisfied. Under this condition, even if the image sensor 132a is used in the orientation of being rotated 90 degrees, the image sensor 132a cannot receive light from the entire captured image.

Thus, when the approach A or the approach D is used in the fourth specific example, the imaging unit 132 can capture the projected image without causing a decrease in the spatial resolution of the captured image nor causing a considerable increase in cost.

Hence, the imaging unit 132 can capture the projected image without causing a decrease in the spatial resolution of the captured image nor causing a considerable increase in cost by optimizing the size of the image sensor 132a and the size of a captured image in a direction where the value of L/M is large in the X-axis direction and in the Z-axis direction as in the third specific example and the fourth specific example.

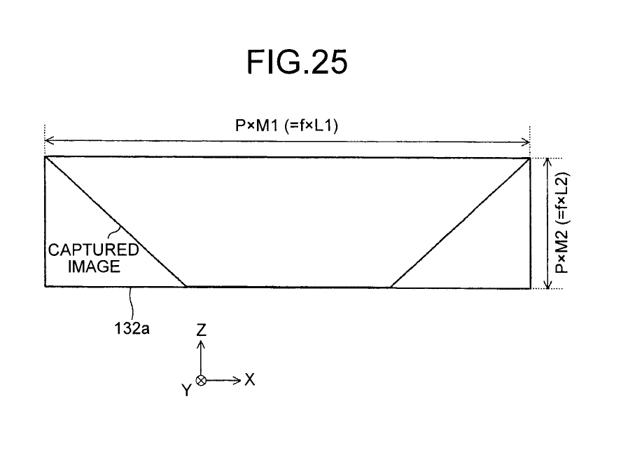

Note that the approach C or the approach F is applicable when at least any one of the number of pixels of the image sensor 132a and the shape of the captured image is adjustable. Under this condition, the imaged image can be tightly enclosed within the image sensor 132a in the X-axis direction and in the Z-axis direction as illustrated in FIG. 25, for example.

However, in practice, dimensional error is introduced during assembly of the imaging optical system 132b and the image sensor 132a and/or during machining or the like of the imaging optical system 132b. Accordingly, such a design that makes the size of the captured image precisely identical to the size of the image sensor 132a lacks robustness. For this reason, it may be preferable to configure the captured image to be several percent larger than the image sensor 132a to obtain robustness.

Meanwhile, the value of L/M corresponds to a per-pixel size of the captured image or, put another way, resolution in imaging of the projected image. Therefore, the smaller the value of L/M, the more preferable for high-resolution measurement.

For example, when the approach A is used, the value of P/f is obtained as: P/f=L1/M1=0.00529 in the third specific example; the same is obtained as P/f=L1/M1=0.00489 in the fourth specific example. Accordingly, with the number of pixels of the image sensor 132a fixed, the mount angle of the rangefinder unit 13 of the fourth specific example is more preferable than the mount angle of the rangefinder unit 13 of the third specific example.

More specifically, imaging resolution can be increased by configuring the rangefinder unit 13 so that the optical axis of the rangefinder unit 13 has a tilt angle, with respect to the Y-axis direction, that minimizes the value of L/M in a direction where the value of L/M is large in the X-axis direction and in the Z-axis direction.

As described above, the projector apparatus 10 according to the embodiment includes the projection unit 11, the rangefinder unit 13, and the processing unit 15.

The projection unit 11 projects an image on the screen 300 in accordance with an instruction from the processing unit 15. The rangefinder unit 13 includes the light emitter 131, the imaging unit 132, and the computing unit 133 and obtains a depth map of a projection area containing the input means. The light emitter 131 emits detection light toward the projected image. The imaging unit 132 includes the imaging optical system 132b and the image sensor 132a and captures at least any one of the projected image and the input means. The computing unit 133 receives a result of image capture from the imaging unit 132. The processing unit 15 obtains input operation information indicated by the input means based on the depth map fed from the rangefinder unit 13.

In the Z-axis direction, the rangefinder unit 13 is configured to have a mount angle that places the position where the optical axis of the rangefinder unit 13 intersects the projected image and the rangefinder unit 13 on the same side of the center of the projected image.

Under this condition, increasing the angle of view of the imaging optical system 132b wider than required is prevented. As a result, an increase in detection error can be prevented or at least reduced. Furthermore, because the angle of view of the imaging optical system 132b can be reduced, reduction in cost can be achieved.

In the input-operation-information detection process of the embodiment, it is determined that a fingertip is in contact with a projection surface if the differential distance is equal to or smaller than a preset value (e.g., 3 mm). Performing the determination in this manner allows a desired input operation to be performed even if the distance obtained by the rangefinder unit 13 has an error. Furthermore, performing the determination in this manner is practical because the fingertip is determined as being in contact with the projection surface so long as the fingertip is near the projection surface even if the fingertip is not in contact therewith.

The projector system 100 according to the embodiment includes the projector apparatus 10. Accordingly, the projector system 100 can perform a desired image display operation properly.

In the embodiment, that the projector apparatus 10 and the image management apparatus 30 may be configured in one piece.

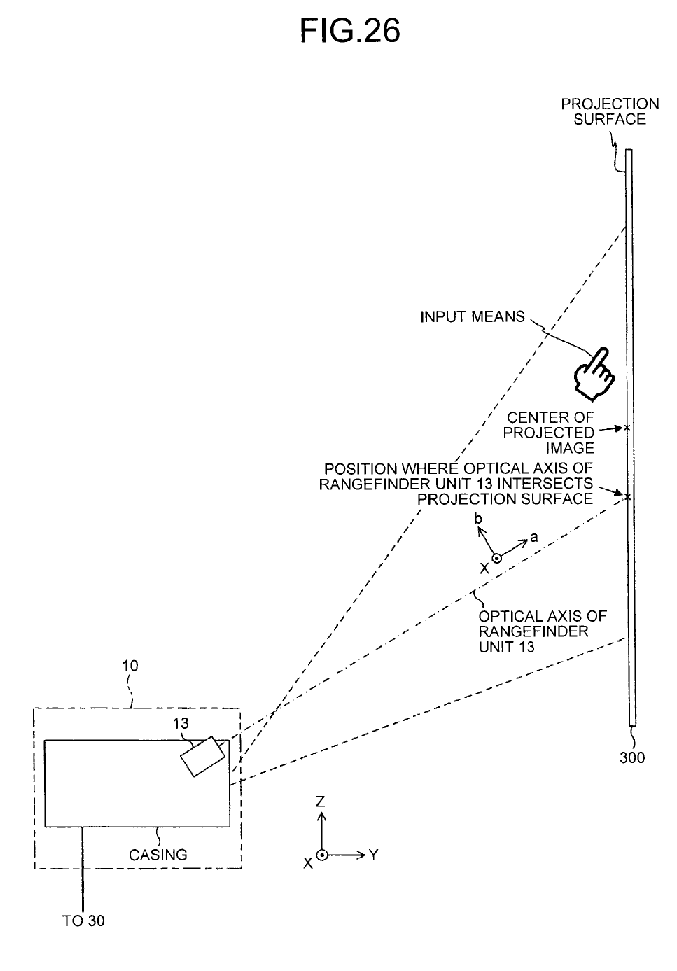

The projector apparatus 10 of the embodiment may be modified, as a first modification, such that the rangefinder unit 13 is externally and removably attached to the casing via a mounting member (not shown) (see FIG. 26). With the first modification of the projector apparatus 10, the depth map obtained by the rangefinder unit 13 may preferably be sent to the processing unit 15 in the casing via a cable or the like. With the first modification of the projector apparatus 10, the rangefinder unit 13 may be arranged at a position away from the casing.

The embodiment described above may be modified such that at least a part of processing performed by the processing unit 15 is performed by the image management apparatus 30. For instance, when the input-operation-information detection process is to be performed by the image management apparatus 30, the depth map obtained by the rangefinder unit 13 may preferably be sent to the image management apparatus 30 via a cable or wirelessly.

The projector apparatus 10 of the embodiment may be modified, as a second modification, such that the projector apparatus 10 includes a plurality of the rangefinder units 13. For instance, in a situation where the angle of view in the X-axis direction is considerably large, a configuration in which a plurality of the rangefinder units 13 each having a less-wide-angle imaging optical system are arranged along the X-axis direction can be less expensive in cost than a configuration in which the single rangefinder unit 13 having a super-wide-angle imaging optical system covers the entire angle of view. In short, the second modification allows providing a projector apparatus having a super-wide angle of view in the X-axis direction less expensively.

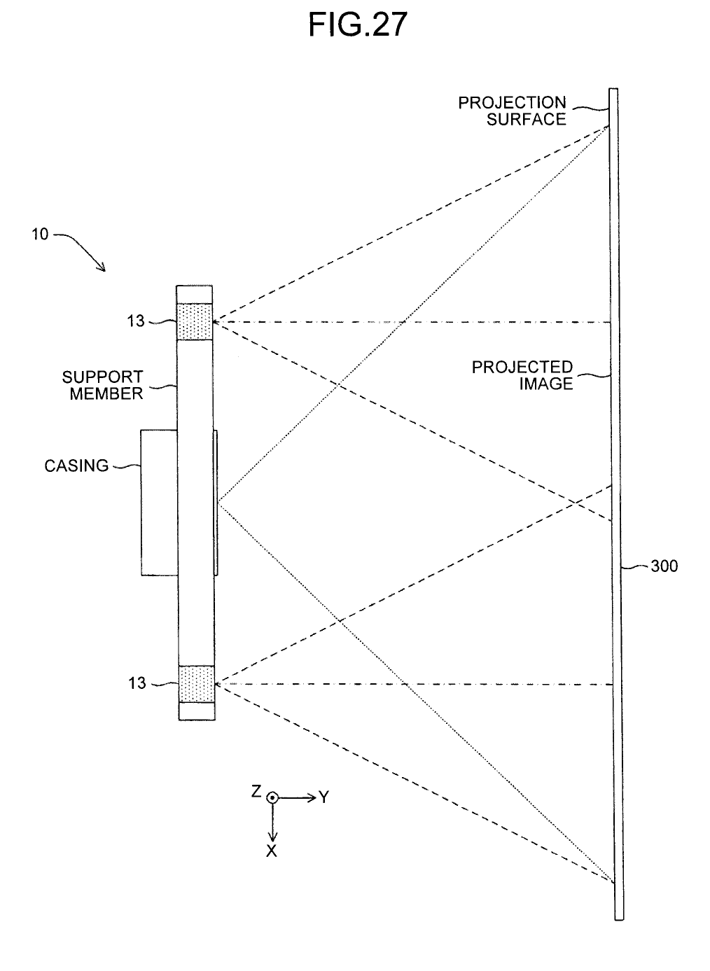

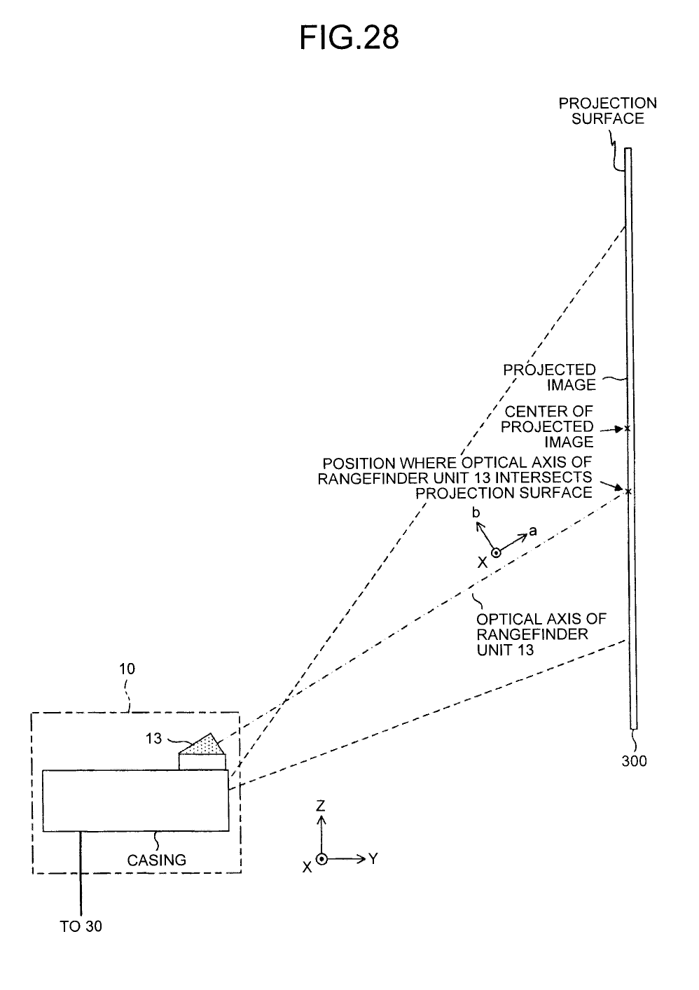

FIG. 27 illustrates an example of the second modification in which the two rangefinder units 13 are arranged along the X-axis direction. In this example, the two rangefinder units 13 are attached to a support member fixed to the casing. Each of the rangefinder units 13 satisfies a condition similar to that of the embodiment in the Z-axis direction (see FIG. 28). With this second modification, depth maps obtained by the two rangefinder units 13 overlap each other at a portion near the center of the projected image. The processing unit 15 couples the two depth maps by utilizing this overlapped portion.

The rangefinder unit 13 of the embodiment may be modified, as a first modification, such that the light emitter 131 emits certain structured light as illustrated in FIG. 29, for example. The “structured light” is light appropriate for what may be known as a structured light technique. Examples of the structured light include stripe-pattern light and matrix-pattern light. As a matter of course, irradiation area is wider than the projected image. Because the structured light to be emitted is near-infrared light, inconvenience that the structured light impairs visibility of the projected image will not occur. With the first modification of the rangefinder unit 13, the imaging unit 132 captures structured light that is deformed when reflected off an image-capture target. The computing unit 133 compares the structured light emitted from the light emitter 131 against the light captured by the imaging unit 132 and obtains a depth map using a triangulation method. This technique is generally referred to as pattern projection.

The rangefinder unit 13 of the embodiment may be modified, as a second modification, such that the light emitter 131 emits light whose intensity is modified at a predetermined frequency as illustrated in FIG. 30, for example. As a matter of course, irradiation area is wider than the projected image. Because the intensity-modified light to be emitted is near-infrared light, inconvenience that the intensity-modified light impairs visibility of the projected image will not occur. With the second modification of the rangefinder unit 13, the imaging unit 132 captures light that is shifted in phase when reflected off an image-capture target. The computing unit 133 compares the intensity-modified light emitted from the light emitter 131 against the light captured by the imaging unit 132 and obtains a depth map based on time difference or phase difference. This method is generally referred to as a TOF (time-of-flight) method.

The rangefinder unit 13 of the embodiment may be modified, as a third modification, such that the light emitter 131 emits texture-imparting light as illustrated in FIG. 31, for example. As a matter of course, irradiation area is wider than the projected image. Because the texture-imparting light to be emitted is near-infrared light, inconvenience that the texture-imparting light impairs visibility of the projected image will not occur. In the example illustrated in FIG. 31, the rangefinder unit 13 includes the two imaging units 132 each captures a texture pattern projected on an image-capture target. Accordingly, there are two optical axes of the respective imaging units. The computing unit 133 calculates a depth map based on parallax between images captured by the two imaging units 132. More specifically, the computing unit 133 applies what may be referred to as stereo image rectification to each of the images, thereby computationally converting into images having parallel optical axes. This conversion eliminates the need that the two optical axes should be parallel to each other. This is generally referred to as computational stereo. The optical axes having undergone the stereo image rectification overlap each other when viewed along the X-axis direction (see FIG. 32). The optical axes correspond to the optical axis of the rangefinder unit 13 of the embodiment.

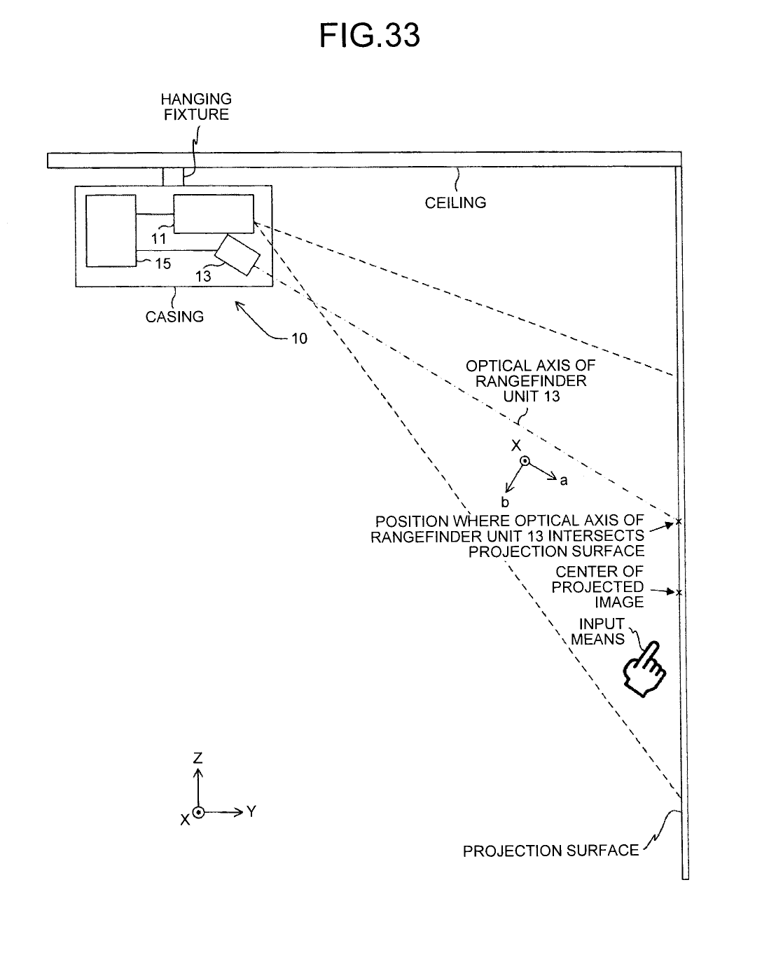

In the embodiment described above, the projector apparatus 10 is used as being placed on the stage 400; however, applicable layout is not limited thereto. For instance, the projector 10 may be modified, as a third modification, so as to be used as being hung from a ceiling as illustrated in FIG. 33. In the illustrated example, the projector 10 is fixed to the ceiling with a hanging fixture.

The input-operation detection device including the rangefinder unit 13 and the processing unit 15 may be used to implement an image display apparatus, such as an interactive whiteboard apparatus and a digital signage apparatus, including an input-operation detection device. In either case, the input-operation detection device can prevent, or at least reduce, an increase in detection error.

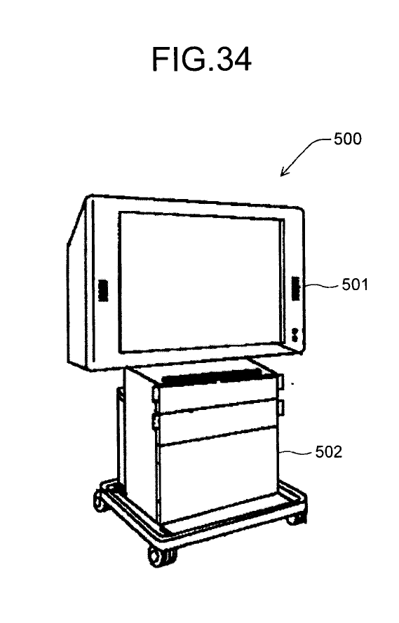

FIG. 34 illustrates an example of the interactive whiteboard apparatus. An interactive whiteboard apparatus 500 (see Japanese Laid-open Patent Application No. 2002-278700) includes a panel part 501, a container part, a support, and an equipment container part 502. A screen panel, on which various menus and results of command execution are to be displayed, and a coordinate input unit are housed in the panel part 501. A controller and a projector unit are housed in the container part. The support supports the panel part 501 and the container part at predetermined heights. A computer, a scanner, a printer, a video cassette player, and the like are housed in the equipment container part 502. The input-operation detection device is housed in the equipment container part 502. Pulling out the equipment container part 502 exposes the input-operation detection device. The input-operation detection device detects an input operation performed by a user on an image projected onto a screen panel from below. Communication between the controller and the input-operation detection device may be either wired communication via a cable such as a USB cable or wireless communication.

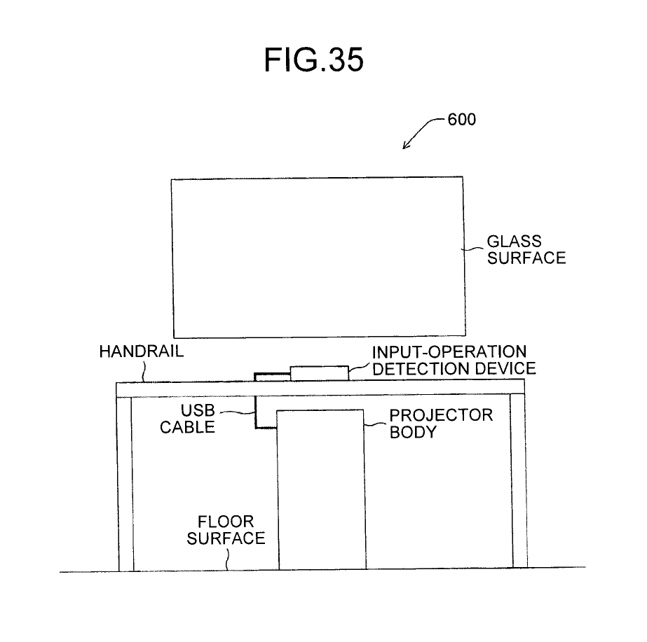

FIG. 35 illustrates an example of the digital signage apparatus. A glass surface of a digital signage apparatus 600 serves as the projection surface. An image is projected by a projector body from a position to the rear of the projection surface using a rear-projection technique. The input-operation detection device is mounted on a handrail. Communication between the projector body and the input-operation detection device is wired communication via a USB cable. This configuration provides the digital signage apparatus with an interactive feature.

As described above, the input-operation detection device including the rangefinder unit 13 and the processing unit 15 is suitable for an apparatus having an interactive feature or an apparatus to which an interactive feature is desirably added.

According to an aspect of the present invention, an input-operation detection device can prevent, or at least reduce, an increase in detection error.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An input-operation detection device for detecting an input operation performed by a user on at least a portion of a displayed image, the input-operation detection device comprising:
a light emitter configured to emit detection light toward an area where the input operation is to be performed;
an imaging unit that includes an imaging optical system, and an image sensor, and that is configured to capture an image of at least one of the displayed image and the input operation and output a result of image capture; and
a processing unit configured to detect position, at which the input operation is performed, or motion, by which the input operation is provided, based on the image capture result output from the imaging unit,
a position where the optical axis of the imaging optical system intersects a display surface of the displayed image and center of the displayed image being on the same side relative to a position at which the imaging unit is mounted.

2. The input-operation detection device according to claim 1, wherein the image capture result output from the imaging unit contains a depth map.

3. The input-operation detection device according to claim 1, wherein an angle of view of the imaging optical system is divided into two equal angles by the optical axis of the imaging optical system.

4. The input-operation detection device according to claim 1, wherein relationship between size of an image captured by the image sensor and number of pixels of the image sensor is optimized in a first direction of the image sensor, the first direction being a direction in which a value of L/M is larger than in a second direction of the image sensor, the first direction and the second direction being perpendicular to each other, L being the size of the image captured by the image sensor, M being the number of pixels of the image sensor.

5. The input-operation detection device according to claim 4, wherein the imaging optical system is configured to have a tilt angle of the optical axis with respect to a direction perpendicular to the display surface, the tilt angle minimizing the value of L/M in the first direction.

6. The input-operation detection device according to claim 1, wherein a value of L/M, L being size of an image captured by the image sensor, M being number of pixels of the image sensor, in a first direction of the image sensor is equal to a value of L/M in a second direction of the image sensor, the first direction and the second direction being perpendicular to each other.

7. The input-operation detection device according to claim 1, wherein the light emitter emits structured light.

8. The input-operation detection device according to claim 1, wherein the light emitter emits intensity-modulated light.

9. The input-operation detection device according to claim 1, wherein the light emitter emits texture-imparting light.

10. An image display apparatus comprising the input-operation detection device according to claim 1.

11. The image display apparatus according to claim 10, wherein the image display apparatus is a projector apparatus.

12. The image display apparatus according to claim 10, wherein the image display apparatus is an interactive whiteboard apparatus.

13. The image display apparatus according to claim 10, wherein the image display apparatus is a digital signage apparatus.

14. A projector apparatus configured to operate in accordance with an input operation performed by a user on at least a portion of a projected image, the projector apparatus comprising:
a light emitter configured to emit detection light toward an area where the input operation is to be performed;
an imaging unit that includes an imaging optical system and an image sensor, and that is configured to capture an image of at least one of the projected image and the input operation and output a result of image capture; and
a processing unit configured to detect position, at which the input operation is performed, or motion, by which the input operation is provided, based on the image capture result output from the imaging unit,
a position where the optical axis the imaging optical system intersects a projection surface of the projected image and center of the projected image being on the same side relative to a position at which the imaging unit is mounted.

15. A projector system comprising:
the projector apparatus according to claim 14; and
a control device configured to perform image control based on the position, at which the input operation is performed, or the motion, by which the input operation is provided, obtained by the projector apparatus.
